(19) United States
(12) Patent Application Publication
(10) Pub. No.: US 2025/0376207 A1
(43) Pub. Date: Dec. 11, 2025

(54) STROLLER

(71) Applicant: GOODBABY CHILD PRODUCTS CO., LTD., Kunshan, Jiangsu (CN)

(72) Inventors: Fusheng MA, Kunshan, Jiangsu (CN); Pingzhong SHI, Kunshan, Jiangsu (CN); Chaoyi QIN, Kunshan, Jiangsu (CN)

(21) Appl. No.: 18/874,862

(22) PCT Filed: Nov. 29, 2022
(86) PCT No.: PCT/CN2022/134955

§ 371 Date: Dec. 13, 2024

(30) Foreign Application Priority Data
Jun. 13, 2022 (CN) 202210660528.6

(51) Int. Cl. B62B 7/08; B62B 7/04; B62B 7/06

(52) U.S. Cl. CPC B62B 7/083; B62B 7/044; B62B 7/068

(57) ABSTRACT

A stroller includes a frame having an unfolded configuration and a folded configuration, the frame has a virtual plane perpendicular to a horizontal plane, a first wheel assembly, a second wheel assembly and a third wheel assembly are disposed below a front portion of the frame, the second wheel assembly and the third wheel assembly are symmetrically arranged relative to the virtual plane. The frame includes: a seat frame configured to be connected with a seat for sitting a child; a front support, wherein the first wheel assembly is disposed at a lower portion of the front support. A rear support includes a left rear support and a right rear support symmetrically arranged relative to the virtual plane, the left rear support and the right rear support are slidably connected to the seat frame respectively.

### TECHNICAL FIELD

The present invention relates to the technical field of children's articles and in particular to a stroller.

### BACKGROUND ART

There is a stroller on the market that has one front wheel and two rear wheels to provide great convenience for children in outdoor activities. However, the folded structure of the stroller is not compact enough, the packaging transportation volume is large, and the stroller is not easy to carry.

### SUMMARY OF THE INVENTION

It is an object of the present invention to provide a stroller having a more compact folded configuration.

In order to achieve the above object, the present invention adopts the following technical solution.

A stroller comprises a frame having an unfolded configuration and a folded configuration, a front wheel assembly disposed below a front portion of the frame, a left rear wheel assembly disposed to the left below a rear portion of the frame, and a right rear wheel assembly disposed to the right below the rear portion of the frame; wherein the frame has a virtual plane perpendicular to a horizontal plane, the left rear wheel assembly and the right rear wheel assembly are symmetrically arranged relative to the virtual plane, and the frame in the unfolded configuration comprises: a seat frame configured to be connected with a seat for sitting a child; a front support, wherein the front wheel assembly is disposed at a lower portion of the front support; a rear support comprising a left rear support and a right rear support symmetrically arranged relative to the virtual plane, wherein the left rear wheel assembly is arranged at a lower portion of the left rear support; the right rear wheel assembly is arranged at a lower portion of the right rear support; upper end portions of the left rear support and the right rear support are slidably connected to the seat frame respectively; a slider slidably disposed on the seat frame in a front-rear direction of the seat frame; a pushing rod, wherein a lower end portion of the pushing rod is rotatably connected to the slider; a side linking rod, wherein a rear end portion of the side linking rod is rotatably connected with the pushing rod, one of a front end portion of the side linking rod, a front end portion of the seat frame and an upper end portion of the front support is pivotally connected to another one of the front end portion of the side linking rod, the front end portion of the seat frame and the upper end portion of the front support, the third one of the front end portion of the side linking rod, the front end portion of the seat frame and the upper end portion of the front support is also pivotally connected to at least one of the other two of the front end portion of the side linking rod, the front end portion of the seat frame and the upper end portion of the front support; and a linkage rod, wherein a front end portion of the linkage rod is rotatably connected to the front support, and a rear end portion of the linkage rod is rotatably connected to the slider.

When the frame is switching from the unfolded configuration to the folded configuration, the upper end portion of the left rear support and the upper end portion of the right rear support slide forwards and towards the virtual plane respectively; and the left rear wheel assembly located at the lower portion of the left rear support and the right rear wheel assembly located at the lower portion of the right rear support also move forwards and towards the virtual plane respectively.

When the stroller of the present invention is folded, the rear wheel assembly is brought together towards the seat frame in the front-rear direction and the left-right direction at the same time, so that the folded structure of the stroller is more compact. The whole volume of the folded stroller can be made smaller than that in the prior art, and it is convenient to carry the stroller.

Preferably, the slider is slidably disposed on the seat frame in a direction parallel to the virtual plane.

Preferably, the slider comprises a left sliding rod and a right sliding rod, the pushing rod comprises a left pushing rod and a right pushing rod, a lower end portion of the left pushing rod is rotatably connected to the left sliding rod, a lower end portion of the right pushing rod is rotatably connected to the right sliding rod; the left sliding rod and the right sliding rod are slidably disposed with respect to the seat frame respectively; and sliding directions of the left sliding rod and the right sliding rod are parallel to the virtual plane respectively.

Preferably, a left guiding rail and a right guiding rail are respectively provided on the seat frame; the left guiding rail and the right guiding rail are symmetrically disposed with respect to the virtual plane; the distance between the left guiding rail and the right guiding rail in the left-right direction becomes gradually smaller from back to front, the upper end portion of the left rear support is slidably connected to the left guiding rail, and the upper end portion of the right rear support is slidably connected to the right guiding rail.

Further preferably, the left guiding rail and the right guiding rail are disposed at the bottom of the seat frame respectively.

Further preferably, the stroller further comprises a left linkage mechanism disposed between the slider and the left rear support, and a right linkage mechanism disposed between the slider and the right rear support.

When the frame is switching from the unfolded configuration to the folded configuration, the slider slides backwards along the seat frame; the left linkage mechanism and the right linkage mechanism drive the upper end portion of the left rear support and the upper end portion of the right rear support respectively to slide forwards along the left guiding rail and the right guiding rail.

When the frame is switching from the folded configuration to the unfolded configuration, the slider slides forwards along the seat frame; the left linkage mechanism drives the upper end portion of the left rear support to slide forwards along the left guiding rail; and the right linkage mechanism drives the upper end portion of the right rear support to slide backwards along the right guiding rail.

Further preferably, the left linkage mechanism and the right linkage mechanism are symmetrically disposed with respect to the virtual plane.

More preferably, the left linkage mechanism comprises a first cable and a first group of guide wheels rotatably disposed on the seat frame, the first cable is wrapped around the first group of guide wheels, the slider and the left rear support are fixedly connected to the first cable respectively; the right linkage mechanism comprises a second cable and a second group of guide wheels rotatably disposed on the seat frame; the second cable is wrapped around the second group of guide wheels, and the slider and the right rear support are fixedly connected to the second cable respectively.

When the slider moves with respect to the left rear support and the slider moves with respect to the right rear support, the first cable and the second cable are maintained tensioning.

More preferably, the first group of guide wheels comprises a first guide wheel and a second guide wheel provided on a left side of a rear portion of the seat frame, and a third guide wheel, a fourth guide wheel and a fifth guide wheel provided on a front portion of the seat frame, wherein the rotation axis of the first guide wheel, the rotation axis of the third guide wheel and the rotation axis of the fourth guide wheel extend in an up-and-down direction respectively, the rotation axis of the second guide wheel and the rotation axis of the fifth guide wheel are substantially perpendicular to the extending direction of the left guiding rail respectively and are substantially perpendicular to the rotation axis of the first guide wheel respectively, the first cable comprises a first section and a second section, wherein one end of the first section is fixedly connected to the front portion of the slider, and the other end of the first section is routed through the first guide wheel and the second guide wheel and is fixedly connected to the upper end portion of the left rear support; one end of the second section is fixedly connected to the front portion of the slider, and the other end of the second section is routed through the third guide wheel, the fourth guide wheel and the fifth guide wheel and is fixedly connected to the upper end portion of the left rear support, the first section and the second section are disposed independently of each other, or the first section and the second section are connected end-to-end to form a closed structure.

Still more preferably, the fifth guide wheel is located at the front portion of the left guiding rail and the second guide wheel is located at the rear portion of the left guiding rail.

Still more preferably, the second group of guide wheels comprises a sixth guide wheel and a seventh guide wheel provided on the right side of the rear portion of the seat frame, and an eighth guide wheel, a ninth guide wheel and a tenth guide wheel provided on the front portion of the seat frame, wherein the rotation axis of the sixth guide wheel, the rotation axis of the eighth guide wheel and the rotation axis of the ninth guide wheel extend in the up-down direction respectively; the rotation axis of the seventh guide wheel and the rotation axis of the tenth guide wheel are substantially perpendicular to the extending direction of the right guiding rail respectively and are substantially perpendicular to the rotation axis of the sixth guide wheel respectively, the second cable comprises a first segment and a second segment, one end of the first segment is fixedly connected to the front portion of the slider, and the other end of the first segment is routed through the sixth guide wheel and the seventh guide wheel and is fixedly connected to the upper end portion of the right rear support, one end of the second segment is fixedly connected to the front part of the slider, and the other end of the second segment is routed through the eighth guide wheel, the ninth guide wheel and the tenth guide wheel in sequence and is fixedly connected to the upper end portion of the right rear support, the first segment and the second segment are disposed independently of each other; or the first segment and the second segment are connected end to end to form a closed structure.

Still more preferably, the tenth guide wheel is located at the front portion of the right guiding rail and the seventh guide wheel is located at the rear portion of the right guiding rail.

Preferably, the seat frame is in plate shape and comprising an upper surface and a lower surface, a receiving cavity extending in a front-rear direction is formed between the upper surface and the lower surface, and at least part of the slider is contained within the receiving cavity.

More preferably, the rear end portion of the slider is pivotally connected to the lower end portion of the pushing rod. When the frame is switching from the folded configuration to the unfolded configuration, the slider slides towards the front end portion of the seat frame; and the distance between the rear end portion of the seat frame and the lower end portion of the pushing rod gradually decreases. When the frame is switching from the unfolded configuration to the folded configuration, the slider slides towards the rear end portion of the seat frame; and the distance between the rear end portion of the seat frame and the lower end portion of the pushing rod gradually increases.

More preferably, the left sliding rod and the right sliding rod are symmetrically disposed with respect to the virtual plane and are extended in a front-rear direction respectively, the slider further comprises a transverse linking rod extending in a left-right direction, two ends of the transverse linking rod are fixedly connected to the left sliding rod and the right sliding rod respectively, and the rear end portion of the linkage rod is pivotally connected to a middle portion of the transverse linking rod. This arrangement prevents the movement of the linkage rod from preventing the left rear support and the right rear support from sliding on the seat frame during the folding process of the stroller.

Still further preferably, the left sliding rod and the right sliding rod are both located within the receiving cavity.

Preferably, when the frame is switching from the unfolded configuration to the folded configuration, part of the slider extends rearwardly out of the seat frame.

Preferably, when the frame is switching from the unfolded configuration to the folded configuration, the pushing rod is flipped forwardly and downwardly towards the seat frame and the front support is flipped rearwardly and upwardly towards the seat frame. The whole stroller can be folded or unfolded only by operating the pushing rod. Since the front and rear wheels are always supported on the ground during folding, the front and rear wheels can be rolled during folding, and the folding is easy.

Preferably, when the frame is in the folded configuration, the front wheel assembly is positioned at a middle position between the left rear wheel assembly and the right rear wheel assembly. The whole stroller is folded to have a small volume for convenient storage and transportation. In some embodiments, the touchdown point of the front wheel assembly, the touchdown point of the left rear wheel assembly, and the touchdown point of the right rear wheel assembly together constitute a support plane for supporting the frame. The stroller is small and stably standing on a horizontal ground after being folded. In other embodiments, the touchdown point of the front wheel assembly, the touchdown point of the left rear wheel assembly, and the touchdown point of the right rear wheel assembly are on the same straight line, and the straight line where the touchdown point of the front wheel assembly, the touchdown point of the left rear wheel assembly, the touchdown point of the right rear wheel assembly are located, and the slider and/or the touchdown point of the pushing rod together constitute a support plane for supporting the frame so that the whole folded stroller can stably stand on the horizontal ground.

Due to the application of the above technical solution, the present invention has the following advantages compared with the prior art. When the stroller of the present invention is folded, the rear wheel assembly can be brought together with the seat frame in both the front-rear direction and the right-left direction, resulting in a more compact and less bulky structure.

### BRIEF DESCRIPTION OF THE DRAWINGS

FIG. 1 is a perspective view of a stroller of the present embodiment with a frame in an unfolded configuration;

FIG. 2 is a rear view of a stroller of the present embodiment with a frame in an unfolded configuration;

FIG. 3 is a perspective view of a stroller of the present embodiment with the frame in a semi-folded configuration;

FIG. 4 is a side view of the stroller of the present embodiment with the frame in a semi-folded configuration;

FIG. 5 is a perspective view of a stroller of the present embodiment with a frame in a folded configuration;

FIG. 6 is a side view of the stroller of the present embodiment with the frame in a folded configuration;

FIG. 7 is a side view of the stroller of the present embodiment with the frame in an unfolded configuration (the left rear support and left rear wheel assembly not shown, the seat frame showing a cross-sectional view);

FIG. 8 is a side view of the stroller of the present embodiment with the frame in a semi-folded configuration (the left rear support and left rear wheel assembly not shown, the seat frame showing a cross-sectional view);

FIG. 9 is a side view of the stroller of the present embodiment with the frame in a folded configuration (the left rear support and left rear wheel assembly not shown, the seat frame showing a cross-sectional view);

FIG. 10 is a side view of a partial structure of the stroller of the present embodiment with the frame in an unfolded configuration (showing the seat frame and the upper end portion of the left rear wheel support);

FIG. 11 is a bottom view of FIG. 10;

FIG. 12 is a cross-sectional view taken along the line A-A in FIG. 10;

FIG. 13 is a cross-sectional view taken along the line B-B in FIG. 10;

FIG. 14 is a side view of a partial structure of the stroller of the present embodiment with the frame in a folded configuration (showing the seat frame and the upper end of the left rear wheel support);

FIG. 15 is a bottom view of FIG. 14;

FIG. 16 is a cross-sectional view taken along the line C-C of FIG. 14;

FIG. 17 is an exploded view of the partial structure shown in FIG. 10;

FIG. 18 is an exploded view of the partial structure shown in FIG. 10 from another perspective; and

FIG. 19 is a perspective view of the left linkage mechanism of FIG. 17;

In the above-mentioned drawings,
100, virtual plane;
1, frame; 11, seat frame; 111, receiving cavity; 12, front support; 13, left rear support; 14, right rear support, 15, slider; 151, left sliding rod; 152, right sliding rod; 153, transverse linking rod; 16, pushing rod; 161, left pushing rod; 1611, left lower pushing rod; 1612, upper left pushing rod; 162, right pushing rod; 1621, right lower pushing rod; 1622, upper right pushing rod; 171, left side linking rod; 172, right side linking rod; 18, linkage rod;
2, front wheel assembly;
3, left rear wheel assembly;
4, right rear wheel assembly;
51, left guiding rail; 52, right guiding rail;
61, left linkage mechanism; 611, first section; 612, second section; 613, first guide wheel; 614, second guide wheel; 615, third guide wheel; 616, fourth guide wheel; 617, fifth guide wheel; 62, right linkage mechanism; 621, first segment; 622, second segment; 623, sixth guide wheel; 624, seventh guide wheel; 625, eighth guide wheel; 626, ninth guide wheel; 627, tenth guide wheel.

### DETAILED DESCRIPTION OF THE INVENTION

The technical solutions in the embodiments of the invention will be described clearly and completely in conjunction with the accompanying drawings in the embodiments of the invention. Obviously, the described embodiments are only part of the embodiments of the invention, rather than all of the embodiments. Based on the embodiments in the invention, all other embodiments obtained by a person skilled in the art without involving any inventive effort are within the scope of protection of the invention.

In describing the present invention, it should be noted that the terms “front”, “rear”, “left”, and “right” are defined with reference to the direction in which the frame of the stroller is viewed facing forwards when a child sits on the stroller in an unfolded configuration, and are merely intended to facilitate and simplify the description of the present invention are not intended to indicate or imply that the device or element being referred to must have a particular orientation, be constructed and operated in a particular orientation, and should not be construed as limiting the invention. Furthermore, the terms “first” and “second” are used for descriptive purposes only and are not to be construed as indicating or implying relative importance.

In the description of the present invention, the rotation axis of the guide wheel and the extending direction of the guide rail being substantially perpendicular means that the angle between the rotation axis of the guide wheel and the extending direction of the guide rail is in the range of 80° to 100°, and the same effect can be achieved substantially in this range of angles.

In the description of the invention, the slidable connection of the upper end portion of the rear support to the seat frame comprises one of the following three situations. In the first case, a sliding groove is provided below the seat frame, and an upper end portion of the rear support is inserted into the sliding groove and slidably connected thereto. In the second case, a slider is pivotally connected to the upper end portion of the rear support. In particular, a sliding sleeve is selected, and the slider is slidably connected to the seat frame. In the third case, a roller is pivotally connected to the upper end portion of the rear support, and the roller is slidably connected along a rail on the seat frame.

In the description of the present invention, unless otherwise specified, it is described that the frame 1 is in an unfolded configuration.

Examples provide a preferred embodiment of a stroller, in particular a running bike, is provided. The stroller comprises a frame 1 having an unfolded configuration and a folded configuration, a front wheel assembly 2 arranged below a front portion of the frame 1, a left rear wheel assembly 3 arranged below a rear portion of the frame 1 to the left, and a right rear wheel assembly 4 arranged below a rear portion of the frame 1 to the right. The frame 1 has a virtual plane 100, the virtual plane 100 being perpendicular to the horizontal plane, and the left rear wheel assembly 3 and the right rear wheel assembly 4 are symmetrically arranged with respect to the virtual plane 100.

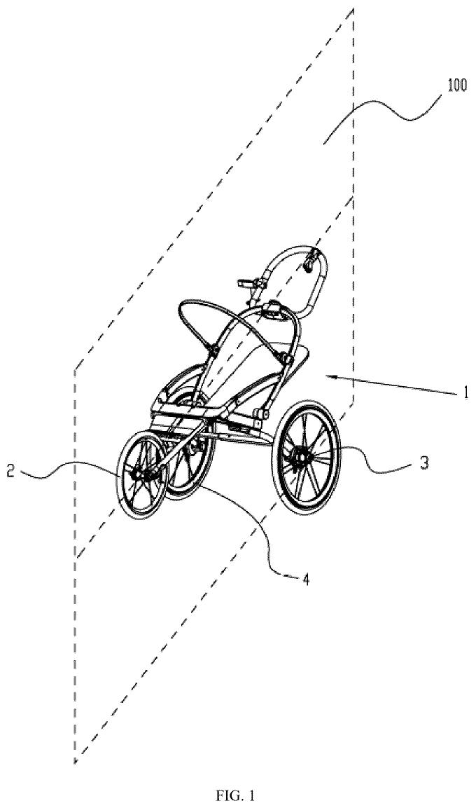

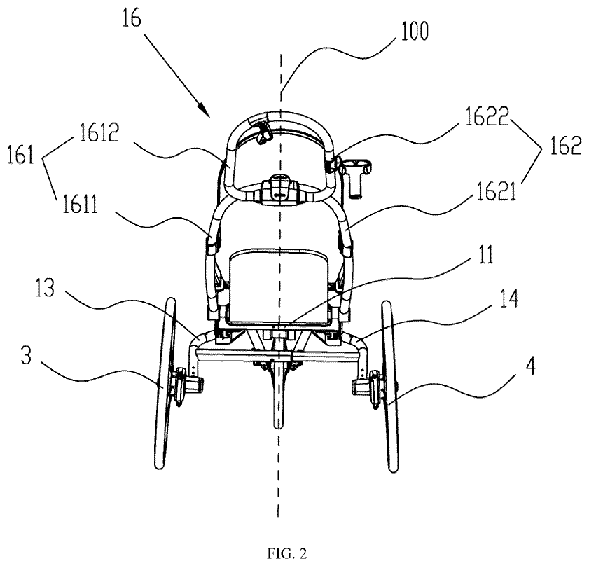

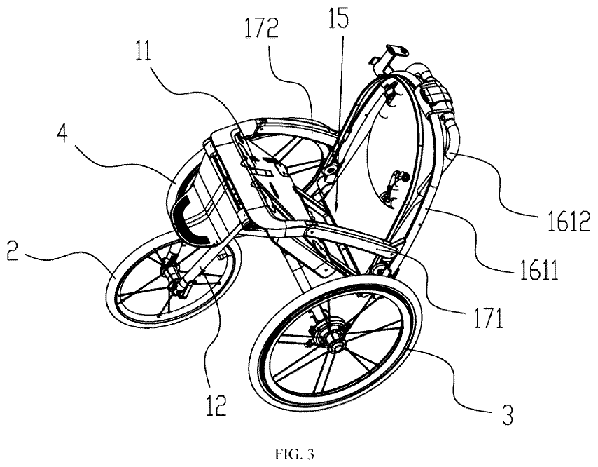

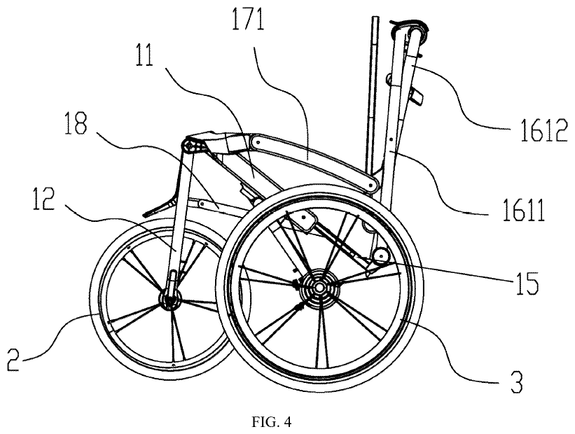

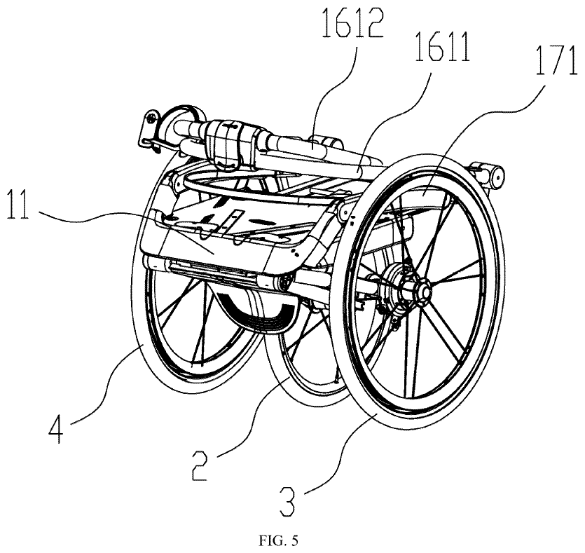

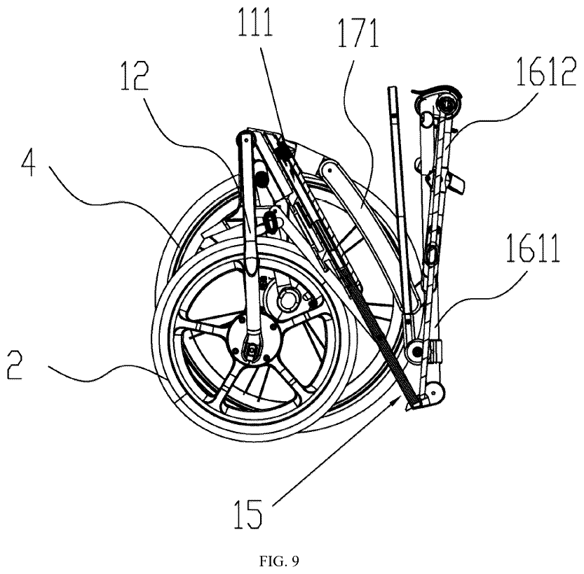

Referring to FIGS. 1 to 9, the frame 1 includes a seat frame 11, a front support 12, a rear support, a slider 15, a pushing rod 16, a side linking rod, and a linkage rod 18. When the frame 1 is in an unfolded configuration, the seat frame 11 extends in a front-rear direction, and the seat frame 11 is used for connecting a seat for sitting a child. The front support 12 extends obliquely upwards from the front to the rear, an upper end portion of the front support 12 is rotatably connected to a front end portion of the seat frame 11, and the front wheel assembly 2 is arranged at a lower portion of the front support 12. The rear support comprises a left rear support 13 and a right rear support 14 which are symmetrically arranged with respect to the virtual plane 100. The left rear support 13 and the right rear support 14 respectively extend obliquely downwards from the front to the rear. The upper end portions of the left rear support 13 and the right rear support 14 are respectively slidably connected to the bottom of the seat frame 11, the left rear wheel assembly 3 is arranged at the lower portion of the left rear support 13, and the right rear wheel assembly 4 is arranged at the lower portion of the right rear support 14. A slider 15 is slidably provided on the seat frame 11 in the front-rear direction of the seat frame 11. The pushing rod 16 extends obliquely upwards from the front to the rear, and a lower end portion of the pushing rod 16 is rotatably connected to a rear end portion of the slider 15. The rear end portion of the side linking rod is rotatably connected to the middle portion of the pushing rod 16. The front end portion of the side linking rod is rotatably connected to the front portion of the seat frame 11, and the upper end portion of the front support 12 is rotatably connected to the front end portion of the seat frame 11. In other embodiments, the rotational connection relationship among the front end portion of the side linking rod, the front end portion of the seat frame 11, and the upper end portion of the front support 12 can be adjusted so that two of the front end portion of the side linking rod, the front end portion of the seat frame 11, and the upper end portion of the front support 12 are rotatably connected, and the third one is rotatably connected to one of the above-mentioned two. A front end portion of the linkage rod 18 is rotatably connected to a middle portion of the front support 12, and a rear end portion thereof is rotatably connected to the slider 15.

When the frame 1 is switching from the unfolded configuration to the folded configuration, the upper end portion of the left rear support 13 and the upper end portion of the right rear support 14 slide forwards and towards the virtual plane 100 respectively; and the left rear wheel assembly 3 located at the lower portion of the left rear support 13 and the right rear wheel assembly 4 located at the lower portion of the right rear support 14 also move forwards and towards the virtual plane 100 respectively.

In the present embodiment, the pushing rod 16 has a left pushing rod 161 and a right pushing rod 162 which are separated on the left and right sides, and the left pushing rod 161 and the right pushing rod 162 respectively comprise a lower pushing rod and an upper push rod. The left pushing rod 161 comprises a left lower pushing rod 1611 and a left upper pushing rod 1612 which are rotatably connected, and the right pushing rod 162 comprises a right lower pushing rod 1621 and a right upper pushing rod 1622 which are rotatably connected. The lower end portion of the lower pushing rod on each side is rotatably connected to the rear end portion of the slider 15. The side connecting rod comprises a left side connecting rod 171 and a right side connecting rod 172 which are respectively provided on the left and right sides. A front end portion of the left side connecting rod 171 is rotatably connected to a left side of the front portion of the seat frame 11, and a rear end portion of the left side connecting rod 171 is rotatably connected to a middle portion of the left lower pushing rod 1611. A front end portion of the right side linking rod 172 is rotatably connected to a right side of the front portion of the seat frame 11, and a rear end portion of the right side linking rod 172 is rotatably connected to a middle portion of the right lower pushing rod 1621.

Specifically, referring to FIG. 8, the seat frame 11 has a plate shape having an upper surface and a lower surface with a receiving cavity 111 extending in the front-rear direction formed therebetween, and at least part of the slider 15 is located in the receiving cavity 111. During the transition of the frame 1 from the unfolded configuration to the folded configuration, the slider 15 slides rearwards so that the partial slider 15 extends rearwards out of the seat frame 11. A left guiding rail 51 and a right guiding rail 52 are symmetrically disposed on the seat frame 11 with respect to the virtual plane 100. The distance between the left guiding rail 51 and the right guiding rail 52 in the left-right direction becomes gradually smaller from back to front. An upper end portion of the left rear support 13 is slidably connected to the left guiding rail 51, and an upper end portion of the right rear support 14 is slidably connected to the right guiding rail 52.

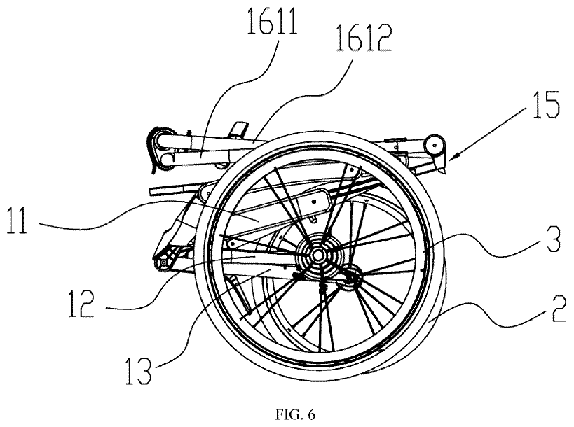

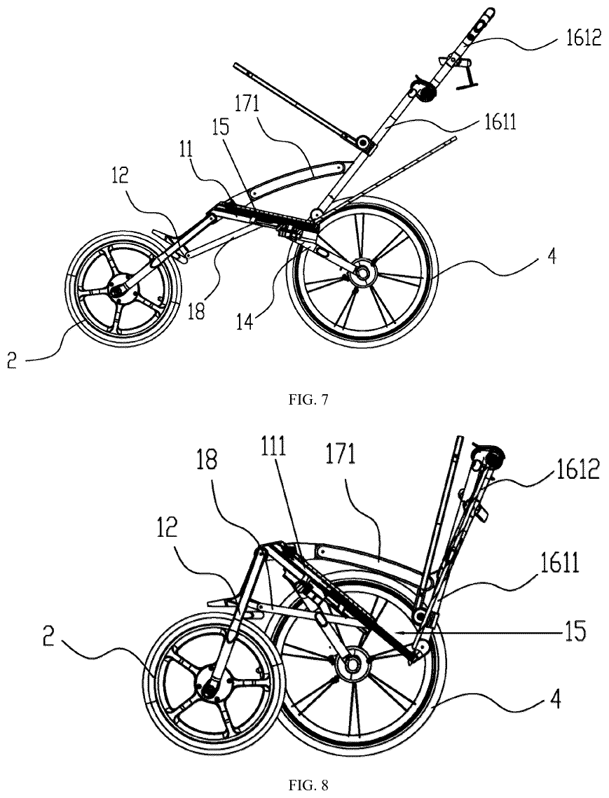

In the present embodiment, referring to FIGS. 7 to 9, when the frame 1 is in the unfolded configuration, the slider 15 extends in the front-rear direction, and the rear end portion of the slider 15 is pivotally connected to the lower end portion of the pushing rod. Both the left guiding rail 51 and the right guiding rail 52 are disposed at the bottom of the seat frame 11. When the frame 1 is in the unfolded configuration, the pivotal connection between the slider 15 and the pushing rod 16 exposes the receiving cavity 111 of the seat frame 11, and the lower end portion of the pushing rod 16 is close to the rear end portion of the seat frame 11. When the frame is switching from the unfolded configuration to the folded configuration 1, the pushing rod 16 is flipped forwards and downwards to close the seat frame 11, the slider 15 extends rearwards out of the seat frame 11, and the front support 12 is flipped rearwards and upwards to close the seat frame 11.

Specifically, the stroller also includes a left linkage mechanism 61 disposed between the slider 15 and the left rear support 13, and a right linkage mechanism 62 disposed between the slider 15 and the right rear support 14. When the frame 1 is switching from the unfolded configuration to the folded configuration, the slider 15 slides backwards along the seat frame 11, the left linkage mechanism 61 drives the upper end portion of the left rear support 13 to slide forwards along the left guiding rail 51, and the right linkage mechanism 62 drives the upper end portion of the right rear support 14 to slide forwards along the right guiding rail 52. When the frame 1 is switching from the folded configuration to the unfolded configuration, the slider 15 slides forwards along the seat frame 11, the left linkage mechanism 61 drives the upper end portion of the left rear support 13 to slide backwards along the left guiding rail 51, and the right linkage mechanism 62 drives the upper end portion of the right rear support 14 to slide backwards along the right guiding rail 52.

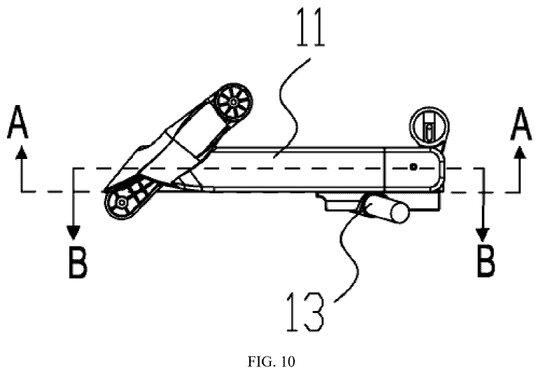

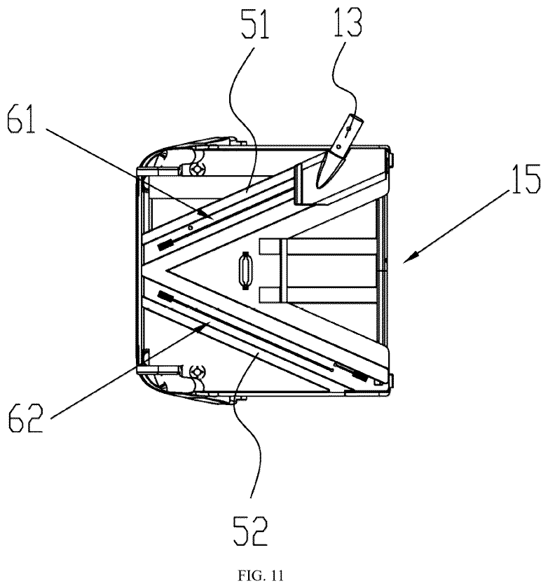

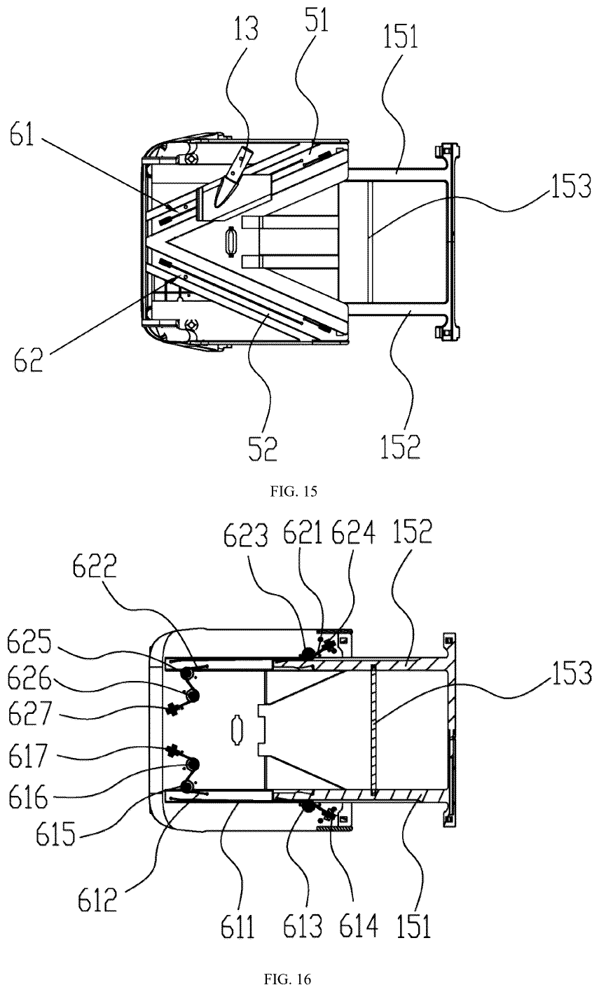

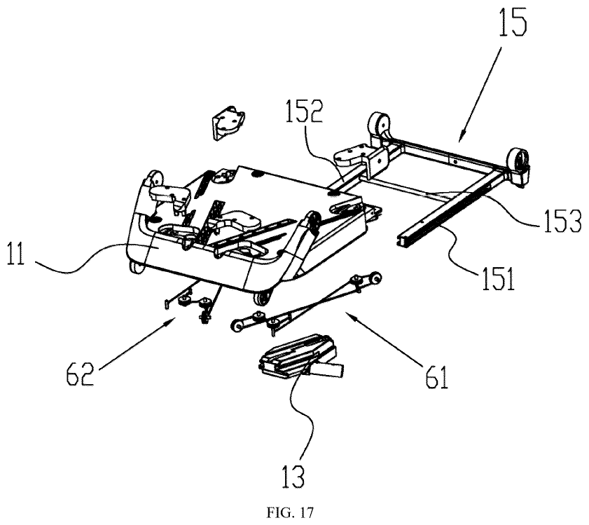

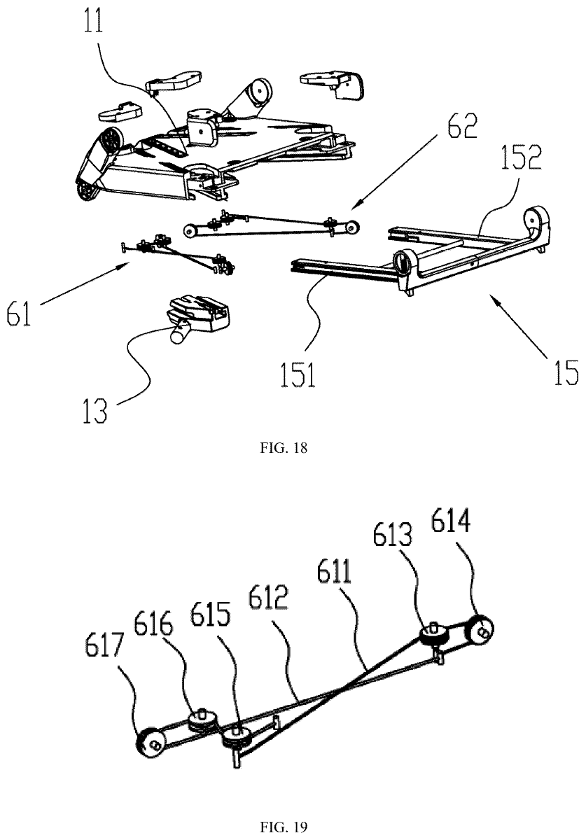

In the present embodiment, referring to FIGS. 11-19, the left linkage mechanism 61 and the right linkage mechanism 62 are symmetrically disposed with respect to the virtual plane 100. The left linkage mechanism 61 comprises a first cable and a first group of guide wheels pivotally arranged on the seat frame 11. The first cable is wound around the first group of guide wheels, and the slider 15 and the left rear support 13 are respectively fixedly connected to the first cable. The right linkage mechanism 62 comprises a second cable and a second group of guide wheels rotatably disposed on the seat frame 11. The second cable is wound around the second group of guide wheels and the slider 15 and the right rear support 14 are respectively fixedly connected to the second cable. During the relative movement of the slider 15 and the left rear support 13, the first cable and the second cable are always maintained tensioning.

More specifically, the first group of guide wheels includes a first guide wheel 613 and a second guide wheel 614 provided on the rear left side of the seat frame 11, and a third guide wheel 615, a fourth guide wheel 616 and a fifth guide wheel 617 provided on the front left side of the seat frame 11. The rotation axis of the first guide wheel 613, the rotation axis of the third guide wheel 615 and the rotation axis of the fourth guide wheel 616 extend in the up-down direction, respectively. The rotation axis of the second guide wheel 614 and the rotation axis of the fifth guide wheel 617 are respectively substantially perpendicular to the extension direction of the left guiding rail 51 and are respectively substantially perpendicular to the rotation axis of the first guide wheel 613. The first cable comprises a first section 611 and a second section 612. One end of the first section is fixedly connected to the front part of the slider 15, and the other end thereof is routed through the first guide wheel 613 and the second guide wheel 614 and is fixedly connected to the upper end portion of the left rear support 13. One end of the second section is fixedly connected to the front portion of the slider 15, and the other end is routed through the third guide wheel 615, the fourth guide wheel 616 and the fifth guide wheel 617 and is fixedly connected to the upper end portion of the left rear support 13. In this embodiment, the fifth guide wheel 617 is located at the front portion of the left guiding rail 51, and the second guide wheel 614 is located at the rear portion of the left guiding rail 51. In this embodiment, the first section 611 and the second section 612 are arranged independently of each other. In other embodiments, the first cable 611 and the second section of the first cable 611 may be connected end-to-end to form a closed structure.

More specifically, the second group of guide wheels includes a sixth guide wheel 623 and a seventh guide wheel 624 disposed on the right side of the rear portion of the seat frame 11, and an eighth guide wheel 625, a ninth guide wheel 626 and a tenth guide wheel 627 disposed on the right side of the front portion of the seat frame 11. The rotational axis of the sixth guide wheel 623, the rotational axis of the eighth guide wheel 625 and the rotational axis of the ninth guide wheel 626 extend in the up-down direction, respectively. The rotation axis of the seventh guide wheel 624 and the rotation axis of the tenth guide wheel 627 are respectively substantially perpendicular to the extension direction of the right guiding rail 52 and are respectively substantially perpendicular to the sixth guide wheel 623. The second cable comprises a first segment 621 and a second segment 622. One end of the first segment is fixedly connected to the front portion of the slider 15, and the other end thereof is routed through the sixth guide wheel 623 and the seventh guide wheel 624 and fixedly connected to the upper end portion of the right rear support 14. One end of the second cable 622 of the second section is fixedly connected to the front portion of the slider 15, and the other end is routed through the eighth guide wheel 625, the ninth guide wheel 626 and the tenth guide wheel 627 and is fixedly connected to the upper end portion of the right rear support 14. In this embodiment, the tenth guide wheel 627 is located at the front portion of the right guiding rail 52, and the seventh guide wheel 624 is located at the rear portion of the right guiding rail 52. In this embodiment, the first segment 621 and the segment 622 are arranged independently of each other. In other embodiments, the first segment and the second segment may be connected end-to-end to form a closed structure.

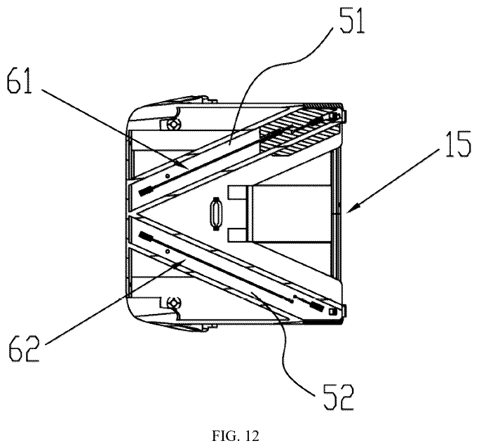

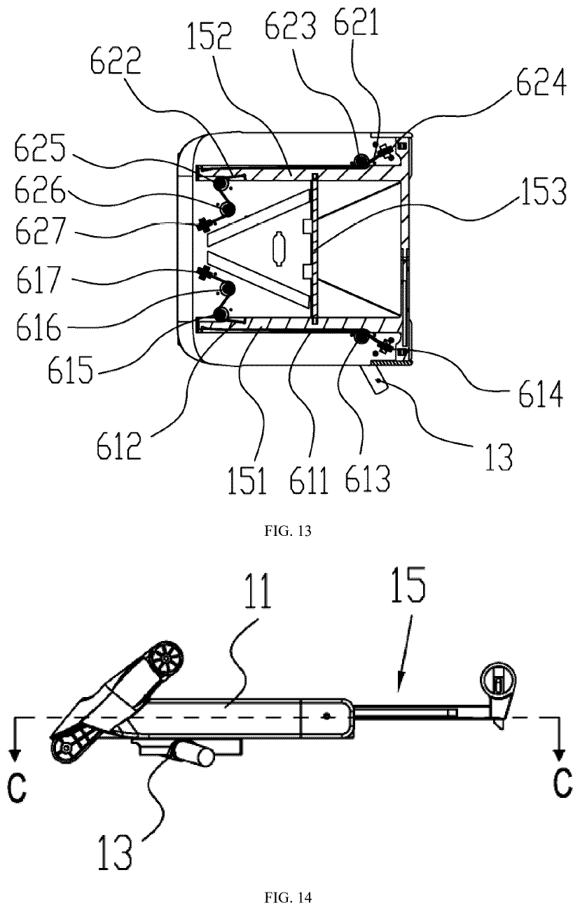

In this embodiment, referring to FIGS. 13, 15, and 16 to 18, the slider 15 includes a left sliding rod 151 and a right sliding rod 152 which are symmetrically disposed with respect to the virtual plane 100 and extend in the front-rear direction, respectively, and both of which are located in the receiving cavity 111. The slider 15 further includes a transverse linking rod 153 extending in the left-right direction, and both end portions of the transverse linking rod 153 are fixedly connected to the left sliding rod 151 and the right sliding rod 152, respectively. The front support 12 comprises a left front support and a right front support disposed on the left and right sides of the front wheel assembly 2. An upper end portion of the left front support is rotatably connected to a left front end portion of the seat frame 11. An upper end portion of the right front support is rotatably connected to a right front end portion of the seat frame 11. The front support 12 further comprises a pedal fixedly disposed between the left front support and the right front support. The linkage rod 18 is disposed on the virtual plane 100. A front end portion of the linkage rod 18 is pivotally connected to the foot pedal, and a rear end portion of the linkage rod 18 is pivotally connected to a middle portion of the transverse linking rod 153. When the frame 11 is switching between the unfolded configuration and the folded configuration, the linkage rod 18 always moves on the virtual plane 100 without interfering with the movement of the left rear support 13 and the right rear support 14. The first cable is disposed between the left sliding rod 151 and the left rear support 13. One end of the first cable 611 of the first section is fixedly connected to the front portion of the left sliding rod 151, and the other end is routed through the first guide wheel 613 and the second guide wheel 614 and is fixedly connected to the upper end portion of the left rear support 13. One end of the second section 612 is fixedly connected to the front portion of the left sliding rod 151, and the other end is routed through the third guide wheel 615, the fourth guide wheel 616 and the fifth guide wheel 617 and is fixedly connected to the upper end portion of the left rear support 13. The second cable is disposed between the right sliding rod 152 and the right rear support 14. One end of the first segment 621 is fixedly connected to the front portion of the right sliding rod 152, and the other end is routed through the sixth guide wheel 623 and the seventh guide wheel 624 and is fixedly connected to the upper end portion of the right rear support 14. One end of the second segment 622 is fixedly connected to the front portion of the right sliding rod 152, and the other end is routed through the eighth guide wheel 625, the ninth guide wheel 626 and the tenth guide wheel 627 and is fixedly connected to the upper end portion of the right rear support 14. In this embodiment, when the frame 1 is in the unfolded configuration, the transverse linking rod 153 is in the receiving cavity 111 of the seat frame 11 and in the middle of the seat frame 11. When the frame 1 is in the folded configuration, the transverse linking rod 153 exposes the rear end portion of the seat frame 11.

### Folding Principle of the Stroller of the Embodiment:

When the frame 1 is switching from the unfolded configuration to the folded configuration, the upper pushing rod is firstly flipped backwards and downwards to be close to the lower pushing rod, then the upper portion of the lower pushing rod is flipped forwards and downwards, and the slider 15 is driven to slide backwards relative to the seat frame 11. The slider 15 drives the linkage rod 18 to slide backwards relative to the seat frame 11, and the linkage rod 18 drives the front support 12 to turn backwards and upwards, so that the front wheel assembly 2 is closed downwards of the seat frame 11. At the same time, the sliders 15 respectively drive the upper portions of the left and right rear supports 13 and 14 to slide on the seat frame 11 forwards from the rear end portion of the seat frame 11 and in a direction close to the virtual plane 100 via a linkage mechanism, so that the left rear wheel assembly 3 and the right rear wheel assembly 4 approach the seat frame 11 in both the front-rear direction and the left-right direction of the frame 1.

When the frame 1 is in the folded configuration, the front wheel assembly 2 is located at an intermediate position between the left rear wheel assembly 3 and the right rear wheel assembly 4, and the touchdown point of the front wheel assembly 2, the touchdown point of the left rear wheel assembly 3 and the touchdown point of the right rear wheel assembly 4 together constitute a support plane for supporting the frame 1 such that the folded stroller stably stands on a horizontal ground.

The above mentioned are only preferred embodiments of the invention. It will be appreciated by those skilled in the art that some modifications and adaptations may be made without departing from the principle of the invention, and such modifications and alterations are intended to be included within the scope of the invention.

1-15. (canceled)

16. A stroller, comprising a frame having an unfolded configuration and a folded configuration, the frame has a virtual plane perpendicular to a horizontal plane, a first wheel assembly, a second wheel assembly and a third wheel assembly are disposed below a front portion of the frame, the second wheel assembly and the third wheel assembly are symmetrically arranged relative to the virtual plane, wherein the frame comprises:
a seat frame configured to be connected with a seat for sitting a child;
a front support, wherein the first wheel assembly is disposed at a lower portion of the front support;
a rear support comprising a left rear support and a right rear support symmetrically arranged relative to the virtual plane, wherein the second wheel assembly is arranged at a lower portion of the left rear support; the third wheel assembly is arranged at a lower portion of the right rear support; the left rear support and the right rear support are slidably connected to the seat frame respectively;
when the frame is switching from the unfolded configuration to the folded configuration, the left rear support and the right rear support slide forwards and towards the virtual plane respectively; and the second wheel assembly and the third wheel assembly also move forwards and towards the virtual plane respectively.

17. The stroller according to claim 16, wherein the frame further comprises:
a slider slidably disposed on the seat frame in a front-rear direction of the seat frame;
a pushing rod, a lower end portion of the pushing rod is rotatably connected to the slider;
a side linking rod, a rear end portion of the side linking rod is rotatably connected with the pushing rod, one of the side linking rod, the seat frame and the front support is pivotally connected to another one of the side linking rod, the seat frame and the front support, the third one of the side linking rod, the seat frame and the front support is also pivotally connected to at least one of the side linking rod, the seat frame and the front support; and
a linkage rod rotatably connected to the front support and the slider respectively.

18. The stroller according to claim 17, wherein the slider is slidably disposed on the seat frame in a direction substantially parallel to the virtual plane.

19. The stroller according to claim 17, wherein the slider comprises a left sliding rod and a right sliding rod, the pushing rod comprises a left pushing rod and a right pushing rod, the left pushing rod is rotatably connected to the left sliding rod, the right pushing rod is rotatably connected to the right sliding rod, the left sliding rod and the right sliding rod are slidably disposed with respect to the seat frame respectively, and sliding directions of the left sliding rod and the right sliding rod are substantially parallel to the virtual plane respectively.

20. The stroller according to claim 17, wherein a left guiding rail and a right guiding rail are respectively provided on the seat frame, the left guiding rail and the right guiding rail are symmetrically disposed with respect to the virtual plane, the distance between the left guiding rail and the right guiding rail in the left-right direction becomes gradually smaller from back to front, the left rear support is slidably connected to the left guiding rail, and the right rear support is slidably connected to the right guiding rail.

21. The stroller according to claim 20, wherein the left guiding rail and the right guiding rail are disposed at the bottom of the seat frame respectively.

22. The stroller according to claim 20, wherein the stroller further comprises a left linkage mechanism disposed between the slider and the left rear support, and a right linkage mechanism disposed between the slider and the right rear support;
when the frame is switching from the unfolded configuration to the folded configuration, the slider slides backwards along the seat frame; the left linkage mechanism drives the left rear support to slide forwards along the left guiding rail, the right linkage mechanism drives the right rear support to slide forwards along the right guiding rail; when the frame is switching from the folded configuration to the unfolded configuration, the slider slides forwards along the seat frame, the left linkage mechanism drives the left rear support to slide backwards along the left guiding rail and the right linkage mechanism drives the right rear support to slide backwards along the right guiding rail.

23. The stroller according to claim 22, wherein the left linkage mechanism comprises a first cable and a first group of guide wheels rotatably disposed on the seat frame, the first cable is wrapped around the first group of guide wheels, the slider and the left rear support are fixedly connected to the first cable respectively; the right linkage mechanism comprising a second cable and a second group of guide wheels rotatably disposed on the seat frame, the second cable is wrapped around the second group of guide wheels, and the slider and the right rear support are fixedly connected to the second cable respectively.

24. The stroller according to claim 22, wherein the left linkage mechanism and the right linkage mechanism are symmetrically disposed with respect to the virtual plane, when the slider moves with respect to the left rear support and the right rear support respectively, the first cable and the second cable are maintained tensioning respectively.

25. The stroller according to claim 23, wherein each of the first group of guide wheels and second group of guide wheels comprising a first guide wheel and a second guide wheel provided on a rear portion of the seat frame, and a third guide wheel, a fourth guide wheel and a fifth guide wheel provided on a front portion of the seat frame, wherein a rotation axis of the first guide wheel, a rotation axis of the third guide wheel and a rotation axis of the fourth guide wheel are extended in an up-and-down direction respectively, a rotation axis of the second guide wheel and a rotation axis of the fifth guide wheel are substantially perpendicular to the extending direction of the left guiding rail or the right guiding rail respectively and are substantially perpendicular to the rotation axis of the first guide wheel respectively;
each of the first cable and the second cable comprising a first section and a second section, wherein the first section is routed through the first guide wheel and the second guide wheel, the second section is routed through the third guide wheel, the fourth guide wheel and the fifth guide wheel, the first section and the second section are disposed independently of each other, or the first section and the second section are connected end-to-end to form a closed structure.

26. The stroller according to claim 16, wherein the seat frame comprises an upper surface and a lower surface, a receiving cavity extending in a front-rear direction is disposed between the upper surface and the lower surface, and at least part of the slider is contained within the receiving cavity.

27. The stroller according to claim 19, wherein the left sliding rod and the right sliding rod are symmetrically disposed with respect to the virtual plane and are extended in a front-rear direction respectively, the slider further comprises a transverse linking rod extending in a left-right direction with the transverse linking rod are connected to the left sliding rod and the right sliding rod respectively, and the linkage rod is pivotally connected to the transverse linking rod.

28. The stroller according to claim 16, wherein when the frame is switching from the unfolded configuration to the folded configuration, part of the slider extends rearwardly out of the seat frame.

29. The stroller according to claim 16, wherein when the frame is switching from the unfolded configuration to the folded configuration, the pushing rod is flipped forwardly and downwardly towards the seat frame and the front support is flipped rearwardly and upwardly towards the seat frame.

30. The stroller according to claim 16, wherein when the frame is in the folded configuration, the first wheel assembly is positioned at a middle position between the second wheel assembly and the third wheel assembly.
